(19) United States
(12) Patent Application Publication
(10) Pub. No.: US 2022/0072900 A1
(43) Pub. Date: Mar. 10, 2022

(54) Traction Sleeve Roller

(71) Applicant: KSi Conveyor, Inc., Sabetha, KS (US)

(72) Inventors: Cesar F. Francisco, JR., Cissna Park, IL (US); Paul A. Kaeb, Sabetha, KS (US)

(73) Assignee: KSi Conveyor, Inc., Sabetha, KS (US)

(21) Appl. No.: 17/304,408

(22) Filed: Jun. 21, 2021

Related U.S. Application Data
(60) Provisional application No. 62/706,724, filed on Sep. 4, 2020.

(51) Int. Cl. B60B 19/12; B60B 15/26; B60B 15/02

(52) U.S. Cl. CPC B60B 19/12; B60B 15/026; B60B 15/266

(57) ABSTRACT

A traction sleeve roller featuring an inner roller and a secured outer traction sleeve that may be rotatably powered when operable to a motor. The outer traction sleeve may be radially offset from the inner roller by a plurality of supporting members positioned between the outer traction sleeve and the inner roller. The plurality of supporting members may secure a plurality of traction members about the inner roller. The plurality of traction members may have a plurality of traction points. A plurality of outer passages pass between the plurality of traction members. A plurality of inner passages pass between an interior surface of the outer traction sleeve and a surface of the inner roller. A foulant may be directed through the plurality of outer passages into the plurality of inner passages when the traction sleeve roller is engaged with a surface having fouling conditions.

### CROSS REFERENCES

This application claims priority of U.S. Provisional Application Ser. No. 62/706,724 filed 4 Sep. 2020.

### REFERENCE TO RESEARCH

Not Applicable.

### REFERENCE TO CDS

Not Applicable.

### FIELD OF THE INVENTION

The present disclosure relates to rollers, wheels or wheel attachments designed for increasing traction; and vehicles and trailers characterized by having propulsion or ground-engaging means utilizing such wheels alone or for friction driving other wheels.

### BACKGROUND

A foulant is any material that may cause fouling conditions. Various types of foulants may include colloidal (such as mud, clay, and flocs), biological (such as algae, bacteria, and fungi), organic (such as manure, oils, and humics), meteorological (such as snow, ice, and condensation), and scaling (such as mineral precipitates). Examples of surfaces that are commonly fouled comprise: soles of shoes, wheels on equipment, and varied ground surfaces.

When a foulant reduces friction between a surface and an equipment's engaging surface, the functionality of that equipment can be reduced. When a wheel becomes fouled with mud, the engagement of the wheel with a ground surface is reduced. Slipping of the wheel against the surface because of the foulant therebetween reduces friction and may reduce the equipment's functionality. By way of another example, in fouling conditions, engagement may be reduced between a contact drive wheel and a transport tire, such as on a planter. Reduced friction driving between the contact drive wheel and the transport tire (otherwise known as a ground drive wheel) may limit control over the metering of seed from the planter.

### SUMMARY

A traction sleeve roller has an inner roller, an outer traction sleeve, and a plurality of passages. The outer traction sleeve is secured to rotate with the inner roller. The outer traction sleeve is radially offset about a curved surface surrounding the inner roller. A plurality of passages may be a combination of outer and inner passages. Outer passages are disposed through the outer traction sleeve. Inner passages are between the outer traction sleeve and the inner roller.

The outer traction sleeve may have traction members that are non-linear with varied radial height relative to the inner roller. The outer passages may be disposed between the traction members and connected to the inner passages. The inner passages may be disposed between the outer traction sleeve and the inner roller, extending across a lateral width of the inner roller. The inner passages may be disposed between supporting members of the outer traction sleeve. Discharge apertures may be connected to the inner passages. The discharge apertures may be disposed at an end face of the traction sleeve roller and radially below the outer traction sleeve. Traction points may be a radially elevated portion of the traction members. A first traction member may extend laterally across and radially offset from the inner roller. A second traction member may be radially disposed upon the first traction member. The traction points may be spaced apart and correspond to an overlap of the first traction member with the second traction member. The first traction member may be imbricated, or overlap, the second traction member. The traction members that are imbricated may form the traction points thereby giving potions of the traction members a greater radial height than other portions of the traction members. The traction members may be circumferentially stepped. The traction members may have a curved or sinusoidal shape in the form of a sine wave. The outer traction sleeve may be a sheet of metal that is slit and pressed forming the traction members. Alternatively, the outer traction sleeve may be raised expanded metal shaped into a cylinder. Traction points on the traction members may be radially disposed or elevated about the inner roller at a fixed radial distance from the inner roller. The traction points may be laterally spaced apart along the inner roller and at a fixed radial distance from the inner roller. The supporting members may radially offset the outer traction sleeve from the inner roller. The supporting members may be secured to the inner roller parallel to an axis of rotation of the inner roller.

The traction sleeve roller may drive or drive upon an external stationary or moving surface. In such a case, a traction sleeve roller, operably connected to a motor, may be provided for engagement with a transport tire of the portable equipment. Alternatively, the traction sleeve roller may be driven by an external moving surface. In such a case, a traction sleeve roller may be provided for engagement with a drive wheel, where the drive wheel is powered. The traction members of the traction sleeve roller may be engaged with such surfaces. A foulant may be directed through the outer passages into the plurality of inner passages. The foulant may be expelled from between the apparatus and the surface through the inner passages. The foulant may be discharged through the discharge apertures after the foulant has progressed from the outer passages into the inner passages.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 shows a side perspective view of a traction sleeve roller;

FIG. 2 shows a side view of the traction sleeve roller of FIG. 1;

FIG. 3 shows an end perspective view of the traction sleeve roller of FIG. 1;

FIG. 4 shows a flowchart for a method of use for a powered traction sleeve roller;

FIG. 5 shows a flowchart for a method of use for a traction sleeve roller powered by an external moving surface;

FIG. 6 shows a front-side perspective view of a traction sleeve roller in use as described in FIG. 5; and

FIG. 7 shows a front-side perspective view of a traction sleeve roller in use as described in FIG. 4.

### DETAILED DESCRIPTION

The traction sleeve roller may comprise an outer traction sleeve partially enveloping and secured to an inner roller. The outer traction sleeve may improve traction in fouling conditions with a plurality of traction members having a plurality of traction points. The plurality of traction points may push through a foulant when engaged with a surface. Radial or outer passages pass between the traction members and lateral or inner passages pass between the outer traction sleeve and the inner roller. The outer traction sleeve allows communication or a passageway between the plurality of passages. When the traction sleeve engages a surface in fouling conditions, the foulant passes through the outer passages and is directed laterally to the ends of the traction sleeve roller through the inner passages. As the foulant discharges out a plurality of discharge apertures at a base of the traction sleeve roller, the traction sleeve roller may make better contact with the surface. The traction sleeve roller may also provide better traction with a surface having little to no fouling conditions. The plurality of traction points may or may not indent a flexible or inflexible surface based upon the amount of force applied against the surface by the traction sleeve roller. The traction sleeve may drive a surface, such as a rubber wheel, when the traction sleeve roller is driven by a motor. Alternatively, the traction sleeve roller may be driven when engaged with a moving surface. The traction sleeve roller may be used with portable agricultural equipment, such as being used for friction driving the ground engaging wheels of a conveyor through fouling or non-fouling ground conditions. Another example for use of the traction sleeve roller is using the traction sleeve roller to replace a contact drive wheel of a planter. Rather than friction driving the contact drive wheel with the transport tire (otherwise known as a ground drive wheel), the traction sleeve roller may be placed into contact with the transport tire to drive the seed metering device. Alternatively, the traction sleeve roller may be placed between the contact drive wheel and the transport tire.

The traction sleeve roller apparatus may improve traction in fouling or non-fouling conditions, for example, when used with portable equipment. The traction sleeve roller may engage with a surface, such as the ground, a rubber wheel, or other surface. When engaged with a transport tire of portable equipment, the traction sleeve roller may initiate movement of the portable equipment. In the case of a portable grain conveyor, the portable grain conveyor may more easily be moved in relation to a semi-trailer truck than the semi-trailer truck can move in relation to the portable grain conveyor.

In fouling conditions, the traction sleeve roller may improve traction in a friction system when the traction sleeve roller is pivoted into contact with a ground engaging wheel. The traction sleeve roller may be operably connected to a motor. By operating the motor, the wheel is driven by the traction sleeve roller. An accumulation of foulant on the wheel or traction sleeve roller would then be directed through the plurality of outer passages into the plurality of inner passages as the wheel and the traction sleeve roller are engaged to rotate together. The foulant may be discharged through a discharge aperture after the foulant has progressed from the plurality of outer passages into the plurality of inner passages. The discharge aperture may be disposed between the traction sleeve roller and the inner roller.

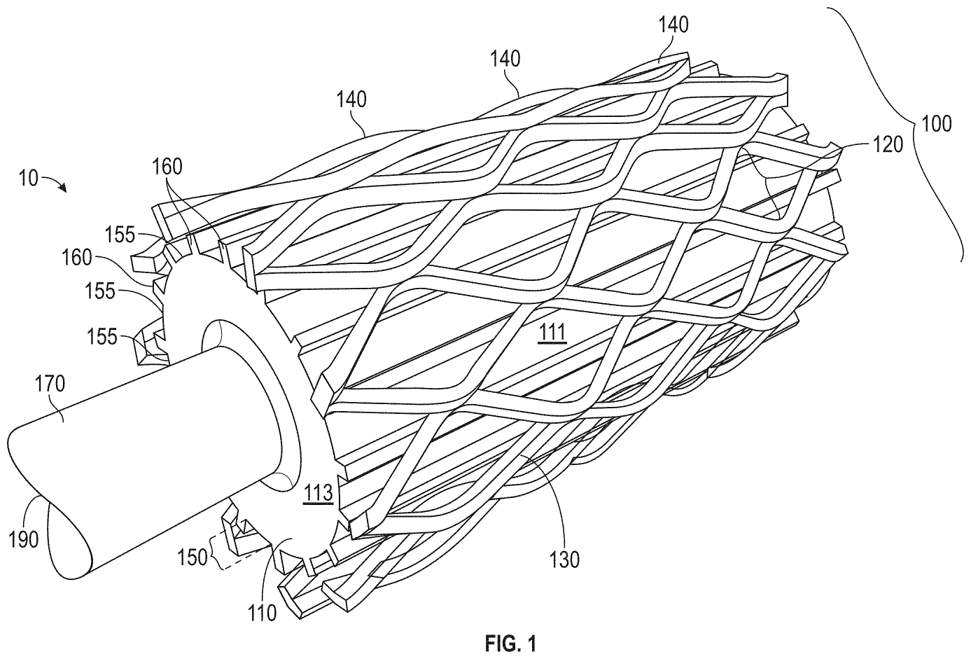

An example of a traction sleeve roller 10 is shown in Figures (FIGS. 1, 2, and 3. An inner roller 110 forms the foundation of the apparatus. The inner roller 110 may be hollow or solid. The inner roller 110 may be made of a durable material such as metal, such as carbon steel, alloy steel, galvanized steel, stainless steel, iron, brass, copper, and aluminum, or may be other materials depending on the application. The inner roller 110 may be cylindrical in shape. The traction sleeve roller 10 may also comprise an outer cylinder 111. The outer cylinder 111 of the inner roller 110 may have a diameter ranging between two inches to six inches (approximately between 50 millimeters (mm) 150 mm). The outer cylinder 111 of the inner roller 110 may have a diameter ranging between three inches to five inches (approximately between 75 mm to 125 mm). The diameter of the outer cylinder 111 of the inner roller 110 may be less than two inches or greater than six inches depending on the needs of the intended application. The inner roller 110 may have a length ranging between eight (approx. 200 mm) to twelve inches (approx. 300 mm). The inner roller 110 may have a length ranging between nine (approx. 225 mm) to twelve inches (approx. 280 mm). The length of the inner roller 110 may be greater than or less than 250 mm depending on the needs of the intended application.

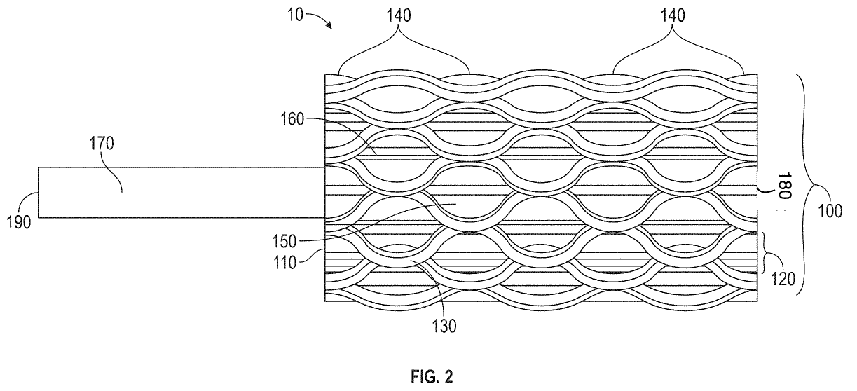

As shown in FIGS. 1 and 2, a shaft 170 may be inserted through and end face 113, 114 of the traction sleeve roller 10. The shaft 170 may be fixed to the inner roller 110. The shaft 170 may be secured to and act as a hub for the inner roller 110 to provide rotational motion to the inner roller 110. The shaft 170 connected to the inner roller 110 may be rotated by a powered source, such as a motor (not shown). Alternatively, the inner roller 110 may be rotated by the powered source. The shaft 170 may be hollow or solid. The shaft 170 may be made of a durable material, such as metal, such as carbon steel, alloy steel, galvanized steel, stainless steel, iron, brass, copper, and aluminum, or other material suited for the application. The shaft 170 may be cylindrical in shape. The shaft 170 may have a diameter less than a diameter of the inner roller 110. For example, the shaft may have a diameter of three inches (approx. 75 mm) when the inner roller 110 is six inches (approx. 150 mm) in diameter. The diameter of the shaft 170 may be greater than, one-half of, or less than the diameter of the inner roller 110 to meet the intended application. A first distal end 190 of the shaft extends from the inner roller 110 or the end face 113, 114 and can be connected to a powered source for transmitting rotational force in a clockwise direction 200, or in a counterclockwise direction 300, through the shaft 170 to the inner roller 110. The shaft 170 may extend through and beyond the inner roller 110 to transmit rotational force from the motor to other devices. In one example, the inner roller may be the shaft or axle.

As shown in FIGS. 1, 2 and 3, a plurality of supporting members 160 may be fixed and secured to the outer cylinder 111 of the inner roller 110. Alternatively, the supporting members 160 may be integral to the inner roller 110. The supporting members 160 may be machined or casted (e.g., mold casting) into the inner roller 110. The plurality of supporting members 160 may be made of a durable material, such as metal or other material suitable for the intended purpose. The plurality of supporting members 160 may be comprised of round rod or keystock metal, such as carbon steel, alloy steel, galvanized steel, stainless steel, iron, brass, copper, and aluminum. The keystock may comprise numerous gauges. Gauges of keystock may comprise 3/16″, ¼″, ⅜″, ½″, ⅝″, ¾″ or larger. Examples of cross-sectional shapes of linear keystock may comprise plain keystock, bar keystock, bilateral keystock, square keystock, rectangular keystock, hexagonal keystock, and rounded keystock. The plurality of supporting members 160 may have a length corresponding to the length of the inner roller 110. The plurality of supporting members 160 may extend along the height of the outer cylinder 111 and be circumferentially spaced apart about the outer cylinder 111. The plurality of supporting members 160 may be attached to the inner roller 110 parallel to an axis of rotation of the inner roller. The supporting members 160 may be formed to wrap around the outer cylinder 111 as an arcuate mold of the outer cylinder 111 of the inner roller. In this form, the plurality of supporting members 160 may be secured to the inner roller 110 perpendicular to an axis of rotation about a center point 180 of the inner roller. In other cases, the plurality of supporting members 160 may be arrayed as spokes, ribs, helices, struts, or a combination thereof. The supporting members 160 may provide support for an overlying outer traction sleeve 100 to rest on, as the outer traction sleeve 100 may not rest on the outer cylinder 111. The supporting members 160 may be discontinuous or continuous about the height, circumference, or other dimension of the inner roller 110.

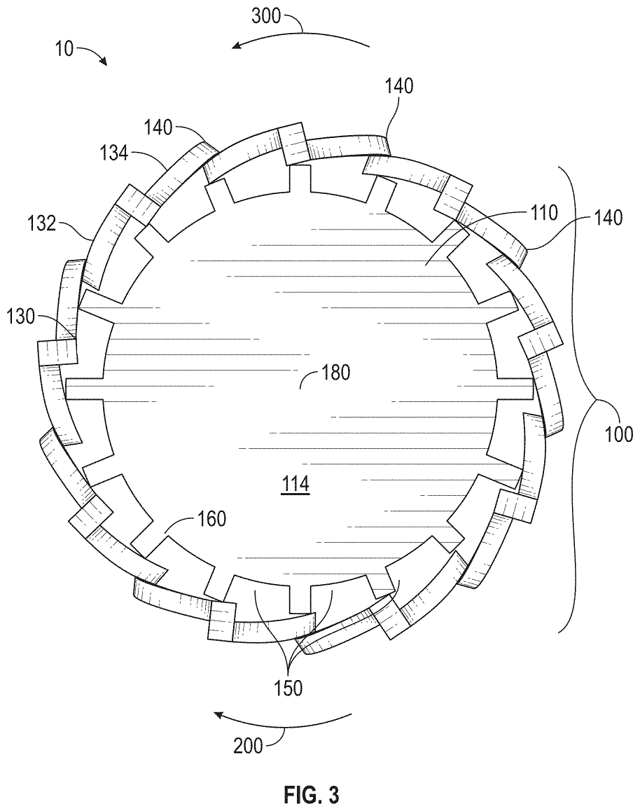

As shown in FIGS. 1, 2, and 3, an outer traction sleeve 100 comprises a plurality of traction members 130 having a plurality of traction points 140 and a plurality of outer passages 120. The outer traction sleeve 100 comprises an interior and an exterior surface. The interior surface of the outer traction sleeve 100 may be fixed and secured to the plurality of supporting members 160. The outer traction sleeve 100 may be made of a durable material such as metal, such as carbon steel, alloy steel, galvanized steel, stainless steel, iron, brass, copper, and aluminum, or other material appropriate for the application. The outer traction sleeve 100 may be formed from plain keystock, bar keystock, bilateral keystock, square keystock, rectangular keystock, hexagonal keystock, and rounded keystock. The keystock may comprise numerous gauges. Gauges of keystock may comprise 3/16″, ¼″, ⅜″, ½″, ⅝″, ¾″, 1″ or larger. The individual traction members may be linear, curvilinear, or otherwise non-linear in shape. Traction members 130 may form a seamless, sinusoidal curve. The traction members 130 may take the form of a plurality of imbricated sine curves (orderly overlapping one another). In such an example, the traction members 130 may have imbricated (orderly overlapping one another) raised ridges wrapped around a cylinder. The traction members 130 may have open or closed cavities therebetween forming the outer passages 120. Portions of individual traction members 130 may have varied radial height relative to the center point 180 of the inner roller 110. As shown in FIG. 3, the traction members 130 are formed into a cylinder partially enveloping the inner roller 110, where a first traction member 132 is radially disposed upon a second traction member 134 when viewed as a cross-section.

The outer traction sleeve 100 may be formed from perforated or serrated sheet metal. Alternatively, the outer traction sleeve 100 may be formed from sheet metal that is slit and pressed to form the traction members 130. Alternatively, the outer traction sleeve 100 may be formed from sheet metal that is slit and stretched. Alternatively, the outer traction sleeve may be formed from flattened, standard, micro, or raised expanded grating or metal. Expanded metal is a product that comes from the press after having been die cut and expanded. Expanded metal can be pressed to expand the sheet metal into a raised configuration or slit and stretched to form a flat configuration. Some examples of expanded metal designs and patterns for forming the plurality of outer passages 120 of the outer traction sleeve 100 may comprise forms such as diamond, circle, square, hexagonal, honeycomb, chevron, or a combination thereof. The metal sheets formed into expanded metal may comprise numerous gauges. Gauges of expanded metal sheets may comprise 3/16″, ¼″, ⅜″, ½″, ⅝″, ¾″, 1″ or larger. The expanded metal may comprise numerous and varied opening sizes. Open areas of the expanded metal may comprise size percentages of 30%, 40%, 48%, 50%, 55%, 58%, 60%, 61%, 66%, 69%, 74%, or 75% open.

The outer traction sleeve 100 may be a formed cylinder of raised expanded metal having a diameter greater than a diameter of the inner roller 110. The cylindrical outer traction sleeve 100 may be supported and secured to the plurality of supporting members 160 or to the inner roller 110 directly. The outer traction sleeve 100, that is cylindrical, may have a diameter of three inches to eight inches (approx. 75 mm to 200 mm). The diameter of the cylindrical outer traction sleeve 100 may be greater than or less than six inches depending on the needs of the intended application. The length of the cylindrical outer traction sleeve 100 may range between eight inches (approx. 200 mm) to twelve inches (approx. 300 mm). The length of the cylindrical outer traction sleeve 100 may be greater than or less than 250 mm depending on the needs of the intended application. The cylindrical outer traction sleeve 100 may be the same height as the inner roller 110. The cylindrical outer traction sleeve 100 may have multiple distinct sections that are disposed along the height of the inner roller 110. The cylindrical outer traction sleeve 100 may be radially disposed and partially envelope the inner roller 110 at a fixed radial distance from the center point 180 of the inner roller 110.

In some cases, the outer traction sleeve 100 may provide improved traction in fouling conditions. The plurality of traction members 130 may have the same radial height. Alternatively, the plurality of traction members 130 may have varied radial heights. The peak radial height of the traction members 130 form a plurality of traction points 140. Alternatively, individual and separate traction points 140 may be secured to the traction members 130. The traction points 140 may be circumferentially stepped around the outer traction sleeve 100, which may provide contact of radially higher or lower traction members with the engaged surface at spaced intervals. In one example, the traction points 140 having varied radial heights may be positioned in a corkscrew pattern to engage the surface in a spiral motion. In another example, the traction points 140 having varied radial height may be spaced about the outer traction sleeve 100 in equal distant positions. Alternatively, the traction points 140 having varied radial height may be spaced about the outer traction sleeve 100 in no particular pattern.

As shown in FIGS. 1, 2, and 3, the circumferentially stepped traction points 140 may have a fixed radial distance or height relative to the center point 180 of the inner roller 110. Traction members 130 that are curved or sinusoidal in shape may form traction points 140 spaced apart. The traction points 140 spaced apart along a sine curve may correspond to the stacked peak and valley of the sine curve. In this example, the traction points 140 may be evenly distributed about the outer traction sleeve 100. The protruding traction points 140 positioned about the outer traction sleeve 100 may contact an engaged surface at staggered points along the longitudinal axis of the traction sleeve roller 10 as it rotates. The sinusoidal shape of the traction members 130 may also provide cupped outer passages 120. The cupped outer passages 120 may catch foulants when the traction sleeve roller 10 engages a surface. When using a cylindrical roll of raised expanded metal about the inner roller 110, a traction point may have an equal lateral distance from another traction point. When using a cylindrical roll of raised expanded metal about the inner roller 110, the traction points 140 may have a greater fixed radial distance from the center point 180 of the inner roller 110 than other members of the outer traction sleeve 100. The plurality of traction points 140 may provide improved traction and may reduce slipping between the outer traction sleeve 100 and a surface engaged. Advantages to having the plurality of traction points 140 at a greater fixed radial distance may be the ability of traction points 140 to initially push through a foulant when engaging a surface. Turbulence generated from rotating the traction sleeve roller 10 against the surface of a wheel 20 may lead to a thinner deposit layer of foulant adhering to the wheel 20 thereby minimizing fouling. Slipping between the traction sleeve roller 10 and the wheel 20 and the wheel 20 and the surface may also be minimized. A thinner deposit layer of foulant adhering to the wheel 20 may lead to enhanced contact between the traction sleeve roller 10 and the wheel 20.

The outer traction sleeve 100 having a plurality of radial or outer passages 120 allows bypass of the foulant through the outer traction sleeve 100. The foulant may pass through the outer passages 120 disposed between the traction members 130. Foulant may move through the plurality of outer passages 120 to the plurality of inner passages 150. The plurality of inner passages 150 may be bound between the outer cylinder 111, supporting members 160, and an interior surface of the outer traction sleeve 100. When the outer traction sleeve 100 is engaged with a surface during fouling conditions, the foulant may pass through the plurality of outer passages 120 and may be directed laterally to the ends of the traction sleeve roller 10 through the plurality of inner passages 150. As the foulant reaches a distal end of the inner passages 150, the foulant may discharge out of the plurality of inner passages 150 through a plurality of discharge apertures 155. The foulant may flow along the surface of the outer cylinder 111 and between the supporting members 160. When the foulant runs along the surface of the outer cylinder 111, the foulant may be expelled away from the traction sleeve roller 10. The foulant may be discharged along an axis perpendicular to a radius of the inner roller 110 and along an axis parallel with the axis of rotation of the inner roller 110 at the center point 180. The foulant may be pushed and expelled through the plurality of discharge apertures 155 as the foulant continues to be directed through the plurality of outer passages 120 into the plurality of inner passages 150. Expulsion of the foulant may increase engagement of the outer traction sleeve 100 with the surface being engaged.

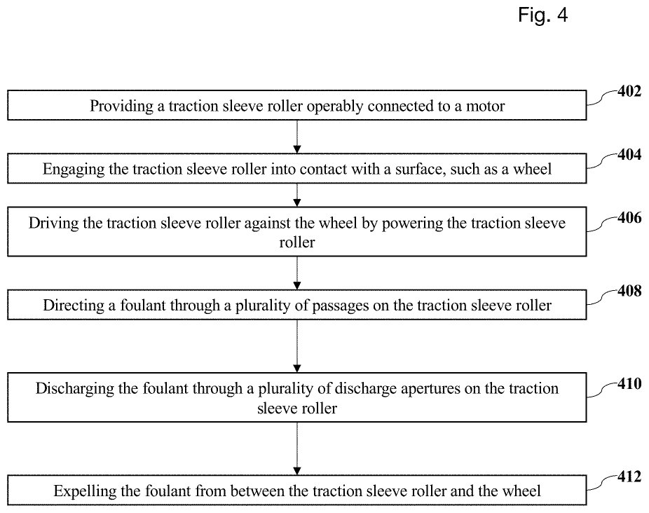

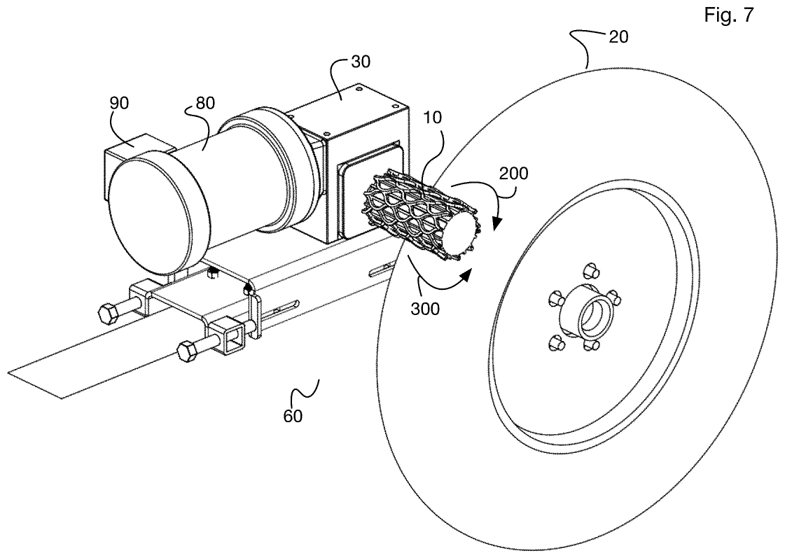

The traction sleeve roller 10 may drive or drive upon an external stationary or moving surface, such as when the traction sleeve roller 10 is internally driven by a motor 80 as described in FIG. 4 and shown in FIG. 7. A traction sleeve roller 10 may be provided and operably connected to the motor 80, according to step 402. The motor 80 may be directly connected to provide internal rotation to a hub of the inner roller 110 with bolts, screws, or other means for fastening. Alternatively, the motor 80 may be connected to the inner roller 110 through the shaft 170, with the shaft acting as an axle to provide internal rotation to the inner roller 110. The motor 80 may be an electric motor connected to a junction box 90 that provides the electric motor with electric power. Alternatively, the motor may be powered by gas, hydraulics, pneumatics, or other means suited for the intended motor used. The motor 80 may be operably connected to the shaft 170 of the traction sleeve roller 10 by a right-angle gearbox 30. The traction sleeve roller 10 may be pivoted into contact with a surface or semi-permanently or permanently connected to the surface. The traction sleeve roller 10 is then engaged to meet the surface, according to step 404. The surface may comprise a wheel 20 on portable equipment 60 that is turned by rotation of the traction sleeve roller 10 such as center pivot irrigation system. The surface may comprise the ground, where the traction sleeve roller 10 drives an implement through its rotation upon the ground. The surface may comprise a belt on a conveyor, where the rotation of the traction sleeve roller 10 turns a belt. The surface may comprise other surfaces to be traversed by an implement, where a traction sleeve roller 10 works independently or in cooperation with additional traction sleeve rollers. The traction sleeve roller 10 may be driven against the surface by operating the motor 80, according to step 406. The powered traction sleeve roller 10 may move the surface that the traction sleeve roller 10 is engaged with or may move an implement upon the surface that the traction sleeve roller 10 is engaged with. The wheel 20 rotates counter to the directional rotation of the traction sleeve roller 10. The wheel 20 may be driven in a clockwise 200 rotation when driven by the traction sleeve roller 10 rotating in a counterclockwise direction 300 and vice versa. The portable equipment 60 may be moved between forward and reverse motions in such cases. In fouling conditions, a foulant may be directed through a plurality of passages away from a point of contact, according to step 408. The foulant may be directed through a plurality of outer passages 120 into a plurality of inner passages 150 that extend along a lateral width of the inner roller 110. The foulant may be discharged through a plurality of discharge apertures 155 on the traction sleeve roller 10, according to step 410. This action may cause the foulant to expel from between the traction sleeve roller 10 and the surface, according to step 412.

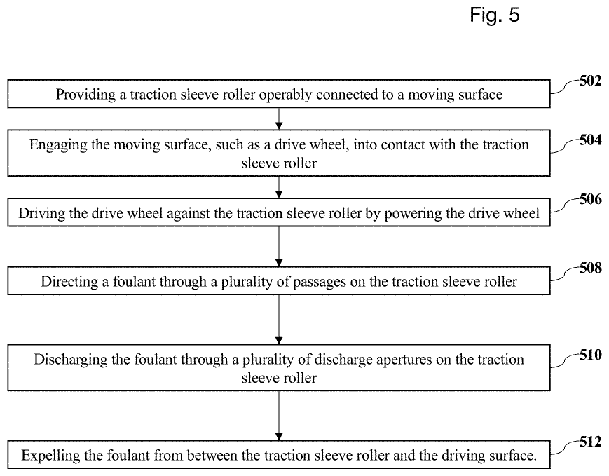

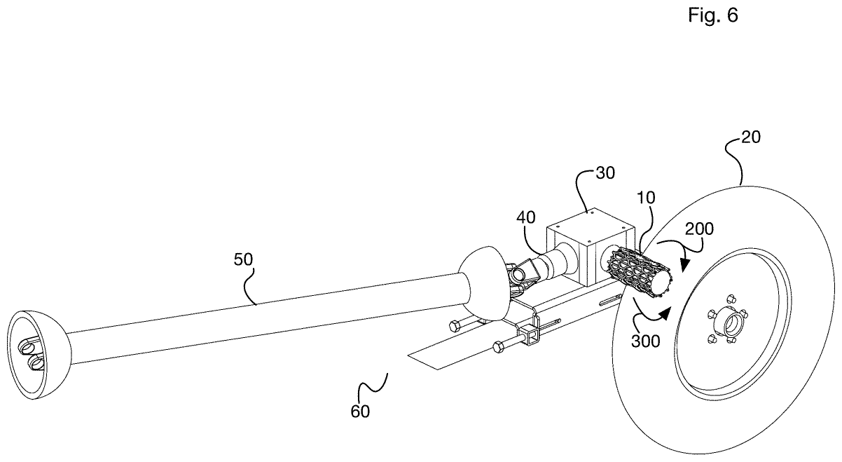

The traction sleeve roller 10 may be driven by an external moving surface. As described in the flowchart of FIG. 5 and shown in FIG. 6, a traction sleeve roller 10 is provided and operably connected to an external moving surface, according to step 502. The moving surface may comprise a drive wheel 20 on portable equipment 60 (such as a drive wheel for controlling the metering of seed on a planter), the ground, a belt on a conveyor, or other surface to be traversed. The drive wheel 20 may be pivoted into contact with the traction sleeve roller 10 or the traction sleeve roller 10 may be moved (by pivoting or otherwise) into contact with the drive wheel 20 or other moving surface. The moving surface is engaged into contact with the traction sleeve roller 10, according to step 504. The moving surface may be driven against the traction sleeve roller 10 by powering the moving surface, such as the drive wheel 20, according to step 506. A foulant may be directed through a plurality of passages on the traction sleeve roller 10, according to step 508. The foulant may more particularly be directed through a plurality of outer passages 120 into a plurality of inner passages 150. The inner passages 150 may be located between the outer surface of an outer cylinder 111 of the inner roller 110, the interior surface of the traction sleeve 100, and the spaced apart supporting members 160. The foulant is discharged through a plurality of discharge apertures 155, according to step 510, after the foulant has progressed from the plurality of outer passages 120 into the plurality of inner passages 150. The foulant may be expelled from between the traction sleeve roller 10 and the driving surface, according to step 512.

As shown in FIG. 6, a power-take-off (PTO) driveline 50 may be made to rotate when operably connected to a traction sleeve roller 10 externally driven by a wheel 20 or the PTO driveline 50 may be powered to drive wheel 20 through traction sleeve roller 10. The traction sleeve roller 10 directionally rotates counter to the directional rotation of the wheel 20. The traction sleeve roller 10 may be driven in a clockwise 200 rotation when externally driven by the wheel 20 rotating in a counterclockwise direction 300 and vice versa. A shaft 170 of the traction sleeve roller 10 may engage a right-angle gearbox 30. The right-angle gearbox 30 will rotate an output shaft 40 of the right-angle gearbox 30. The output shaft 40 may be operably connected to the PTO driveline 50. Another example for use of the traction sleeve roller may comprise turning a seed meter on a planter when used as a friction drive.

Alternatively, the traction sleeve roller 10 may be used as a gear-like device between two movable surfaces such as wheels. A traction sleeve roller 10 placed between two wheels will transfer rotational movement from a first wheel to a second wheel. In one example, the traction sleeve roller 10 may be operably connected to a powered source to transmit rotational motion from the powered source to the wheels. In this case, the wheels will have a rotational direction counter to the rotational motion of the traction sleeve roller 10. In the other example, the wheels may be the powered source and transmit rotational motion to the traction sleeve roller 10 that may provide rotational motion to another piece of connected equipment. In another example, the traction sleeve roller 10 may be used in multiples to engage a surface to provide tractional movement for equipment, a vehicle, or user. In one example, multiple traction sleeve rollers 10 that are bound together and powered may be attached to a wearable device to transport a lineman or equipment up and down a power pole. Alternatively, the traction sleeve roller 10 used in multiples may transport equipment or users horizontally along a pipe run between two attachment points. The traction sleeve roller 10 may be used to translate linear motion into rotational motion, even in fouling conditions and in conditions where the linear surface is yielding (such as soft wood, humus-rich soil, wet ground cover, clay-rich soil) or low friction (such as ice). The traction sleeve roller 10 may also be used to translate rotational motion into linear motion, even in fouling conditions and in conditions where the rotational surface is yielding.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. An apparatus comprising:
a. an inner roller;
b. an outer traction sleeve secured to rotate with the inner roller; and
c. a plurality of passages disposed through the outer traction sleeve and between the outer traction sleeve and the inner roller.

2. The apparatus of claim 1, wherein the outer traction sleeve is a sheet of metal that is slit and pressed to form a plurality of traction members.

3. The apparatus of claim 1, wherein the outer traction sleeve is raised expanded metal in a shape of a cylinder.

4. The apparatus of claim 1, wherein the outer traction sleeve further comprises:
a. a first traction member extending laterally across and radially offset from the inner roller; and
b. a second traction member radially disposed upon the first traction member.

5. The apparatus of claim 4, wherein the first traction member overlaps the second traction member defining a traction point having a greater radial height than other portions of a plurality of traction members.

6. The apparatus of claim 5, wherein the plurality of traction members are circumferentially stepped.

7. The apparatus of claim 1, wherein the outer traction sleeve comprises a plurality of traction members that are non-linear and have varied radial height relative to the inner roller.

8. An apparatus comprising:
a. an inner roller;
b. an outer traction sleeve radially offset from and partially surrounds the inner roller, the outer traction sleeve comprising:
i. a plurality of traction members;
ii. a plurality of outer passages between the plurality of traction members; and
c. a plurality of inner passages disposed between the outer traction sleeve and the inner roller.

9. The apparatus of claim 8, wherein the plurality of inner passages extend across a lateral width of the inner roller.

10. The apparatus of claim 8, wherein the plurality of outer passages are connected to the plurality of inner passages.

11. The apparatus of claim 8, wherein the outer traction sleeve is secured to rotate with the inner roller.

12. The apparatus of claim 8, wherein the plurality of traction members have a plurality of traction points that are radially disposed about the inner roller at a fixed radial distance from the inner roller.

13. The apparatus of claim 8, wherein the plurality of traction members have a plurality of traction points that are laterally spaced apart along the inner roller and at a fixed radial distance from the inner roller.

14. The apparatus of claim 8, further comprising:
a. an end face; and
b. a discharge aperture connected to at least one of the plurality of inner passages, the discharge aperture disposed at the end face.

15. The apparatus of claim 8, wherein the plurality of inner passages are disposed between a plurality of supporting members.

16. The apparatus of claim 15, wherein the outer traction sleeve is radially offset from and partially envelopes the inner roller by the supporting members.

17. The apparatus of claim 15, wherein the plurality of supporting members are secured to the inner roller parallel to an axis of rotation of the inner roller.

18. The apparatus of claim 15, further comprising:
a. where the traction members have a curved shape, are continuous from a first end face of the apparatus to a second end face of the apparatus and are imbricated in a curved surface surrounding the inner roller.

19. The apparatus of claim 18, further comprising:
a. a plurality of traction points are a radially elevated portion of the traction members, which are spaced apart and correspond to an overlap of a first traction member with a second traction member.

20. The apparatus of claim 19, wherein the outer traction sleeve is a sheet of raised expanded metal formed in a cylinder about the inner roller and having a greater diameter than the diameter of the inner roller.

21. A method for improving traction, the method comprising the steps of:
a. providing the apparatus of claim 8; and
b. transferring power between a drive wheel and the apparatus.

22. The method of claim 21, wherein the apparatus comprises:
a. directing a foulant through the plurality of inner passages.

23. The method of claim 22, further comprising the step of:
a. discharging the foulant from the plurality of inner passages through a plurality of discharge apertures disposed radially between one of the plurality of traction members and the inner roller on an end face of the apparatus.

24. A method for improving traction, the method comprising the steps of:
a. providing a traction sleeve roller;
b. operably connecting the traction sleeve roller to a motor; and
c. engaging a plurality of traction members of the traction sleeve roller with a surface; and
d. directing a foulant through the traction sleeve roller.

25. The method of claim 24, further comprising the step of:
a. expelling the foulant from between the traction sleeve roller and the surface.

26. The method of claim 24, further comprising the step of:
a. discharging the foulant through the traction sleeve roller, the traction sleeve roller comprising:
i. a plurality of outer passages;
ii. a plurality of inner passages connected to the outer passages; and
iii. a plurality of discharge apertures at an end face of the traction sleeve roller, wherein the foulant discharges through the plurality of discharge apertures after the foulant is directed from the plurality of outer passages into the plurality of inner passages.
